(19) United States
(12) Patent Application Publication
(10) Pub. No.: US 2016/0065842 A1
(43) Pub. Date: Mar. 3, 2016

(54) VISUAL DATA CAPTURE FEEDBACK

(71) Applicant: Honeywell International Inc., Morristown, NJ (US)

(72) Inventors: Scott McCloskey, Minneapolis, MN (US); Matthew Edward Lewis Jungwirth, Golden Valley, MN (US); Alan Cornett, Andover, MN (US)

(21) Appl. No.: 14/475,201

(22) Filed: Sep. 2, 2014

(51) Int. Cl. H04N 5/232; H04N 1/00

(52) U.S. Cl. CPC H04N 5/23222; H04N 5/23203; H04N 1/00129; H04N 1/00209; H04N 5/23238

(57) ABSTRACT

A system includes a processor having an input to receive images from a remote camera, wherein the images comprise a set of images having predefined requirements for completeness. A display device is coupled to the processor to display images received from the remote camera. The processor performs a perfunctory analysis of the images to meet the requirements for completeness and provides a notification to an operator of the remote camera to obtain further images to meet the requirements for completeness.

### BACKGROUND

In various application domains, there is a need to capture a complete set of visual data under strict time constraints. Medical imaging is one example, where invasive diagnostic imaging is time-limited due to the limited availability of equipment and trained personnel. Additional applications related to computer aided graphics may also operate under time constraints.

In cases where imagery will be analyzed post-capture, there is a need for interactive devices that ensure the camera operator collects a complete set of imagery. Operating under tight time constraints, a rushed capture may miss important data and require a second imaging session. Conversely, an overly-cautious operator may take an unacceptably long time to collect imagery. As such, there is a need for tools to enable the camera operator to capture a complete set of visual data in a minimal time.

### SUMMARY

A system includes a processor having an input to receive images from a remote camera, wherein the images comprise a set of images having predefined requirements for completeness. A display device is coupled to the processor to display images received from the remote camera. The processor performs a perfunctory analysis of the images to meet the requirements for completeness and provides a notification to an operator of the remote camera to obtain further images to meet the requirements for completeness.

A method includes receiving multiple images of a subject from a remote camera, performing a perfunctory analysis of the received images to determine whether the images form a set of images that meet predefined requirements sufficient to provide a complete view of the subject, identifying a further image to add to the set of images, and generating instructions to move the camera to obtain the further image.

A machine readable storage device has instructions for execution by a processor of the machine to perform receiving multiple images of a subject from a remote camera, performing a perfunctory analysis of the received images to determine whether the images form a set of images that meet predefined requirements sufficient to provide a complete view of the subject, identifying a further image to add to the set of images, and generating instructions to move the camera to obtain the further image.

### BRIEF DESCRIPTION OF THE DRAWINGS

FIG. 1 is a block diagram of a system to acquire a complete set of images of a subject according to an example embodiment.

FIG. 2 is a flowchart illustrating a method of acquiring a complete set of images of a subject according to an example embodiment.

FIG. 3 is a diagram illustrating imaging device positioning to obtain a complete set of images of an object according to an example embodiment.

FIG. 4 is a block diagram of a circuitry to implement one or more methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Complete sets of visual data may be captured under time constraints by performing real-time perfunctory analysis and providing feedback to the operator. The analysis may be performed on the live video need not constitute complete analysis, which may still be performed post-capture. Instead, the real-time perfunctory analysis may be limited to determining whether or not the amount of data captured is sufficient, and understanding where additional data may be needed. The result of this analysis may be conveyed to the operator, e.g., an instruction to move the camera a certain way to collect missing data. A wearable device, which may include earphones for audio prompts and/or a display device may be used to provide the instructions to obtain further images, so that the operator's hands are free to manipulate the imaging device.

In various embodiments, an imaging device, a hands-free display, and some provision for image processing and analysis (a laptop, tablet, etc.). Motion tracking is performed in real time as imagery is being acquired, and directions can be issued to the operator to cover areas within a configured target region to ensure coverage criterion are met for capturing a complete view of a subject. Additional criteria may be included, e.g. quality measures to ensure that areas are captured with sufficient sharpness and absence of motion blur. The analysis may include object or feature recognition methods, either to anchor the region of interest or as a criteria for completion.

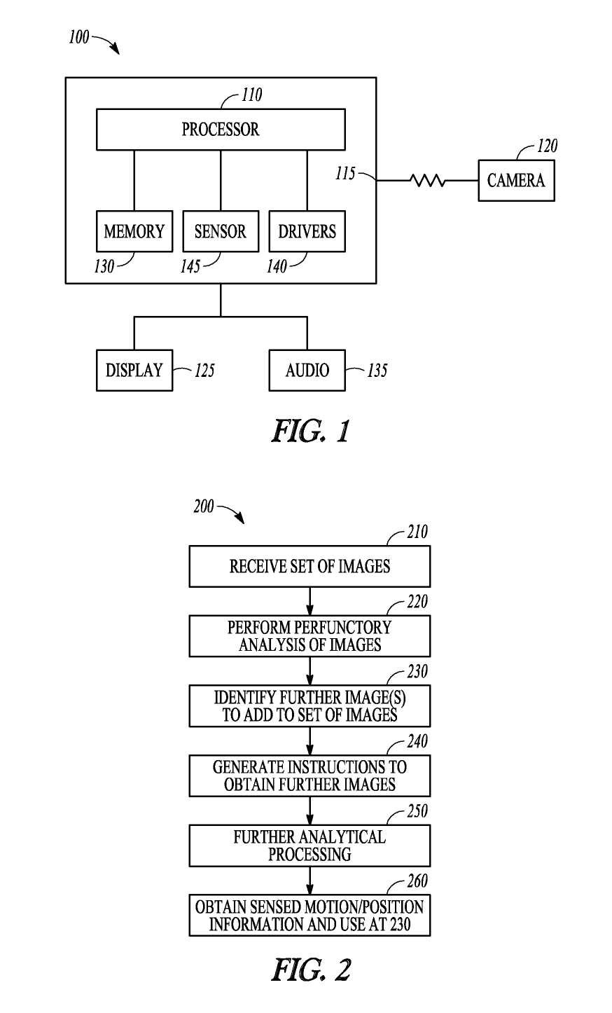

FIG. 1 is a block diagram of a system 100 to facilitate obtaining a complete set of visual data such as images of a subject. The subject may be a panoramic view of scenery, an inside of a length of pipe, a 360 degree view from a fishing camera, or other type of object. The set of images may be taken from a single position, or may be a set of images of an object with sufficient images from different viewpoints to stitch together a 360 degree view of the object, or even a three dimensional view of the object.

In one embodiment, system 100 includes a processor 110 having an input 115 to receive images from an imaging device such as a remote camera 120, either by hardwired or wireless connection. The images comprise a set of images having predefined requirements for capturing a complete view of a subject, referred to as completeness. The requirements may include quality requirements as well as a set of images sufficient to capture the subject to accomplish a purpose, such as performing diagnostic analysis, stitching together the images to obtain a panoramic view without gaps, stitching together images sufficient to inspect a length of pipe or other object, or even obtain a three dimensional view sufficient to create a file suitable for printing a three dimensional model of the object using a 3D printer. The requirements for completeness may vary depending on the application and purpose.

A display device 125 may be coupled to the processor 110 to display images received from the remote camera 120. A memory device 130 is coupled to the processor to provide instructions for execution by the processor 110. The processor 110 uses the instructions to perform a perfunctory analysis of the images to determine if sufficient images have been obtained to provide the complete view of the subject and also provides a notification to an operator of the remote camera to obtain further images to provide the complete view of the subject. The notification may be visual, in which case it is provided via the display 125, or may be an audio notification provided to the user via an audio device indicated at 135, such as a speaker, headphones, wireless earphone or other device over which a user may receive audio instructions. A set of drivers 140 may be provided to interface with the display 125, audio device 135, and camera 120.

In one embodiment, the camera 120 may include an optional sensor 145, such as a motion sensor that includes one or more accelerometers to determine the orientation of the camera for each image. The sensor 145 may also include global positioning circuitry to provide further information about camera location, which may be used in the calculation of further images that may be needed to complete the set of images.

In various embodiments, the predefined requirements of the set of images comprise image quality for a medical diagnostic test. The predefined requirements of the set of images may include a sufficient number of images from various angles and positions to enable stitching the images together to form a complete view of a selected portion of a body, such as a spine, lung, leg, brain, etc. The camera may be an x-ray, echo, or MRI type of machine, or other type of device that is capable of producing images.

In further embodiments, the predefined requirements of the set of images specify a sufficient number of images to obtain a 360 degree view of a length of pipe. The images may be of the inside of the pipe, with the camera being inserted into the pipe and rotated to provide either visual images, x-ray images, or other images of the entire inner circumference of the pipe suitable for inspecting the length of pipe. The images of the pipe may be at least partially orthogonal to the pipe in some embodiments. The camera may also be moved along the length of the pipe to inspect a desired length of pipe. In a further embodiment, the imaging device may be a camera coupled to a fiber optic element to receive images via the fiber optic element.

In still a further embodiment, the imaging device may be an underwater fishing camera which may be used to obtain a 360 degree image at the depth of the camera.

The notification to the operator of the remote camera may describe where to move the camera to obtain complete set of images. The operator may be an electronic control device, or a person in various embodiments. Once a complete set of images has been obtained, the processor 110 may execute instructions to perform additional analysis of the images. The complete set of images may meet requirements that specify images suitable for stitching together to form a full panorama image of a scene having a greater field of view than that of the camera. The additional analysis may include actually stitching the images together to form the panorama image.

The analysis may involve matching the images and ensuring that transitions between images are seamless, which may involve pixel manipulation such as blending and averaging and other image analysis. In the case of medical imaging, stitching may also occur, as well as diagnostic analysis once the complete set of images of suitable quality has been obtained.

In still further embodiments, the complete set of images may be further processed to form a three dimensional view of an object. The complete set of images may then stitched together to form a full view of all sides of the object. The further analysis may involve processing to match the size of the object in each image, which may have been taken from a slightly different distance. The analysis would further include utilizing camera angles to determine depths of parts of the object in order to form an accurate three dimensional representation of the image suitable for display or even 3D printing.

In one embodiment, sensor 145 provides sensed motion information regarding the position of the camera 120 to the processor 110. The processor uses the sensed motion information to generate the notification to the operator of the remote camera to obtain further images. Global position information may also be provided by the sensor 145 and further used to identify images needed to obtain a complete set of images that meet the requirements for the purpose such images are being obtained.

FIG. 2 is a flowchart illustrating a method 200 of obtaining a complete set of images of a subject suitable for an intended purpose. At 210, multiple images of a subject are received from a remote camera. A perfunctory analysis of the received images is performed at 220 to determine whether the images form a set of images that meet predefined requirements sufficient to provide a complete view of the subject. At 230, a further image is identified to add to the set of images. At 240, instructions to move the camera to obtain the further image are generated.

In one embodiment, further analytical processing is performed at 250 to stitch the set of images together to form a complete view of the subject, such as an object or panorama view. The object may be a portion of a body, and the images may be diagnostic images in some embodiments.

In one embodiment, sensed motion and position information may be obtained from the imaging device at 260, and used at 260 to generate the notification to the operator of the remote camera to obtain further images.

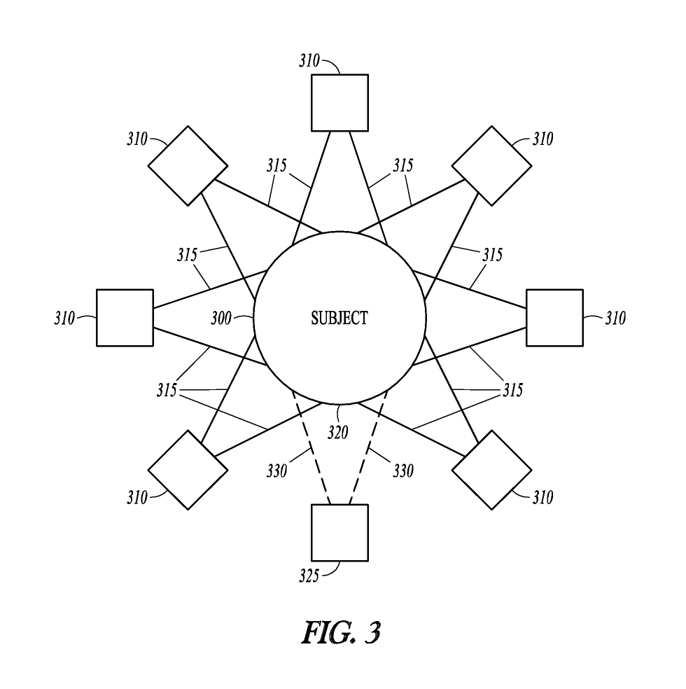

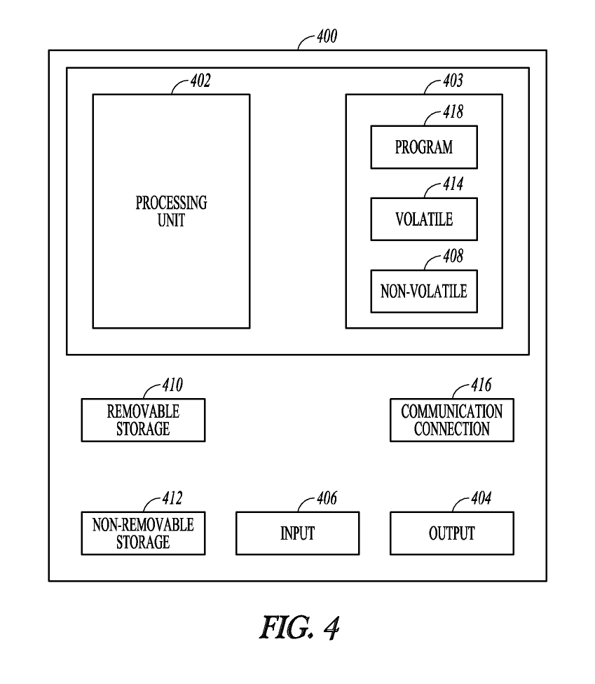

FIG. 3 is an example illustrating obtaining a complete set of images of an object 300. Representations of multiple imaging devices 310 from various angles is illustrated, along with lines 315 representative of the field of view of the imaging devices are shown. Many of the lines 315 illustrate overlapping fields of view of the object 300. In fact, overlapping fields of view may be one of the requirements of the specifications for obtaining a complete set of images of the object. A portion 320 of the object is not captured by a field of view represented by lines 315. The perfunctory processing of the set of images from imaging devices 310 identifies this gap and results in instructions to move an imaging device 325 to the position shown such that a field of view represented by broken lines 330. The instructions are provided to a user or image device positioning mechanism to obtain an image with the field of view so indicated. In one embodiment, each of the imaging devices 310 may represent the same imaging device as it is moved, or may even represent different imaging devices, each providing images to the processor 110.

FIG. 4 is a block schematic diagram of a computer system 400 to implement a controller according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 400, may include a processing unit 402, memory 403, removable storage 410, and non-removable storage 412. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### Examples

1. A system comprising:

a processor having an input to receive images from a remote camera, wherein the images comprise a set of images having predefined requirements for completeness;

a display device coupled to the processor to display images received from the remote camera;

wherein the processor performs a perfunctory analysis of the images to determine if sufficient images have been obtained to meet the requirements for completeness and provides a notification to an operator of the remote camera to obtain further images to meet the requirements for completeness.

2. The system of example 1 wherein the predefined requirements of the set of images comprise a coverage criterion for capturing a complete view of an object.

3. The system of example 2 wherein the predefined requirements of the set of images comprise images suitable to stitch together to form a complete view of an object whose presence and pose is detected by the processor.

4. The system of any of examples 1-3 wherein the predefined requirements of the set of images include an image quality criterion.

5. The system of any of examples 1-4 wherein the notification to the operator of the remote camera describes where to move the camera to obtain the complete set of images.

6. The system of example 5 wherein the complete set of images is suitable for stitching together to form a full panorama image of a scene having a greater field of view than that of the camera.

7. The system of any of examples 1-6 wherein the processor further performs additional analysis of the images once a complete set of images meeting the requirements for completeness has been obtained.

8. The system of any of examples 1-7 wherein the camera is coupled to a fiber optic element.

9. The system of any of examples 1-8 and further comprising a motion sensing device coupled to the processor to provide sensed motion information, and wherein the processor uses the sensed motion information to generate the notification to the operator of the remote camera to obtain further images.

10. The system of any of examples 1-9 wherein the complete set of images is suitable for stitching together to form a full view of all sides of the object.

11. A method comprising:

receiving multiple images of a subject from a remote camera;

performing a perfunctory analysis of the received images to determine whether the images form a set of images that meet predefined requirements sufficient to provide a complete view of the subject;

identifying a further image to add to the set of images; and

generating instructions to move the camera to obtain the further image.

12. The method of example 11 wherein the predefined requirements of the set of images comprise a coverage criterion for capturing a complete view of the subject.

13. The method of example 12 and further comprising performing further analytical processing to stitch the set of images together to form a complete view of the subject.

14. The method of any of examples 11-13 wherein the predefined requirements of the set of images include an image quality criterion.

15. The method of any of examples 11-14 wherein the notification to the operator of the remote camera describes where to move the camera to obtain the complete set of images.

16. The method of example 15 and further comprising performing additional analysis of the images once a complete set of images has been obtained.

17. The method of any of examples 15-16 and further comprising stitching the complete set of images together to form a full panorama image of a scene having a greater field of view than that of the camera.

18. The method of any of examples 11-17 and further comprising:

receiving sensed motion information; and

using the sensed motion information to generate the notification to the operator of the remote camera to obtain further images.

19. A machine readable storage device having instructions for execution by a processor of the machine to perform:

receiving multiple images of a subject from a remote camera;

performing a perfunctory analysis of the received images to determine whether the images form a set of images that meet predefined requirements sufficient to provide a complete view of the subject;

identifying a further image to add to the set of images; and

generating instructions to move the camera to obtain the further image.

20. A machine readable storage device of example 19 wherein the instructions further cause the processor to perform:

receiving sensed motion information; and

using the sensed motion information to generate the notification to the operator of the remote camera to obtain further images.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A system comprising:
a processor having an input to receive images from a remote camera, wherein the images comprise a set of images having predefined requirements for completeness;
a display device coupled to the processor to display images received from the remote camera;
wherein the processor performs a perfunctory analysis of the images to determine if sufficient images have been obtained to meet the requirements for completeness and provides a notification to an operator of the remote camera to obtain further images to meet the requirements for completeness.

2. The system of claim 1 wherein the predefined requirements of the set of images comprise a coverage criterion for capturing a complete view of an object.

3. The system of claim 2 wherein the predefined requirements of the set of images comprise images suitable to stitch together to form a complete view of an object whose presence and pose is detected by the processor.

4. The system of claim 1 wherein the predefined requirements of the set of images include an image quality criterion.

5. The system of claim 1 wherein the notification to the operator of the remote camera describes where to move the camera to obtain the complete set of images.

6. The system of claim 5 wherein the complete set of images is suitable for stitching together to form a full panorama image of a scene having a greater field of view than that of the camera.

7. The system of claim 1 wherein the processor further performs additional analysis of the images once a complete set of images meeting the requirements for completeness has been obtained.

8. The system of claim 1 wherein the camera is coupled to a fiber optic element.

9. The system of claim 1 and further comprising a motion sensing device coupled to the processor to provide sensed motion information, and wherein the processor uses the sensed motion information to generate the notification to the operator of the remote camera to obtain further images.

10. The system of claim 1 wherein the complete set of images is suitable for stitching together to form a full view of all sides of the object.

11. A method comprising:
receiving multiple images of a subject from a remote camera;
performing a perfunctory analysis of the received images to determine whether the images form a set of images that meet predefined requirements sufficient to provide a complete view of the subject;
identifying a further image to add to the set of images; and
generating instructions to move the camera to obtain the further image.

12. The method of claim 11 wherein the predefined requirements of the set of images comprise a coverage criterion for capturing a complete view of the subject.

13. The method of claim 12 and further comprising performing further analytical processing to stitch the set of images together to form a complete view of the subject.

14. The method of claim 11 wherein the predefined requirements of the set of images include an image quality criterion.

15. The method of claim 11 wherein the notification to the operator of the remote camera describes where to move the camera to obtain the complete set of images.

16. The method of claim 15 and further comprising performing additional analysis of the images once a complete set of images has been obtained.

17. The method of claim 15 and further comprising stitching the complete set of images together to form a full panorama image of a scene having a greater field of view than that of the camera.

18. The method of claim 11 and further comprising:
receiving sensed motion information; and
using the sensed motion information to generate the notification to the operator of the remote camera to obtain further images.

19. A machine readable storage device having instructions for execution by a processor of the machine to perform:
receiving multiple images of a subject from a remote camera;
performing a perfunctory analysis of the received images to determine whether the images form a set of images that meet predefined requirements sufficient to provide a complete view of the subject;
identifying a further image to add to the set of images; and
generating instructions to move the camera to obtain the further image.

20. A machine readable storage device of claim 19 wherein the instructions further cause the processor to perform:
receiving sensed motion information; and
using the sensed motion information to generate the notification to the operator of the remote camera to obtain further images.
